(19) United States
(12) Patent Application Publication
(10) Pub. No.: US 2003/0115169 A1
(43) Pub. Date: Jun. 19, 2003

(54) System and method for management of transcribed documents

(76) Inventor: Hongzhuan Ye, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/024,169

(22) Filed: Dec. 17, 2001

(51) Int. Cl. G06F 7/00

(52) U.S. Cl. 707/1

(57) ABSTRACT

A system and method for management of transcribed documents is disclosed. In the preferred embodiment, the system comprises a central file system for storing a plurality of documents, each of the plurality of documents being stored in only one of at least two folders in the central file system based at least in part on a respective status of the plurality of documents. The system also comprises a content indexing module operable to index each of the plurality of documents stored in the central file system based at least in part on the respective content of the plurality of documents stored in the central file system. The system further comprises a document management module operable to manage the processing and distribution of the plurality of documents stored in the central file system in response to, at least in part, the respective status of the plurality of documents.

### RELATED APPLICATION

The present patent application is related to co-pending U.S. patent application, Attorney Docket No. 5953.2-1, entitled “SYSTEM AND METHOD FOR SPEECH RECOGNITION AND TRANSCRIPTION.”

### TECHNICAL FIELD OF THE INVENTION

The present invention relates generally to the field of document management, and more particularly to a system and method for management of transcribed documents.

### BACKGROUND OF THE INVENTION

Speech recognition is a powerful tool for users to provide input to a computer. Because speech does not require the operation of cumbersome input tools such as a keyboard and pointing devices, it is the most convenient manner for issuing commands and instructions, as well as transforming fleeting thoughts into concrete expressions or words. Various tools for converting speech into text are available and may be used to convert spoken words into a transcribed document.

Once speech has been converted into text and stored as a transcribed document, it becomes necessary to manage the editing and distribution of the transcribed document. Although document management tools are currently available, these document management tools are geared towards management of documents in general and do not alleviate the problems associated with management of transcribed documents, especially those that relate to the medical field.

### SUMMARY OF THE INVENTION

Accordingly there is a need in the art for a system and method for management of transcribed documents, such as transcribed documents related to the medical field.

In accordance with an embodiment of the present invention, a transcription management system is disclosed. The transcription management system comprises a central file system for storing a plurality of documents, each of the plurality of documents being stored in only one of at least two folders in the central file system based at least in part on a respective status of the plurality of documents. The transcription management system also comprises a content indexing module operable to index each of the plurality of documents stored in the central file system based at least in part on the respective content of the plurality of documents stored in the central file system. The transcription management system further comprises a document management module operable to manage the processing and distribution of the plurality of documents stored in the central file system in response to, at least in part, the respective status of the plurality of documents.

In accordance with another embodiment of the present invention, a method for management of transcribed documents is disclosed. The method comprises storing a plurality of transcribed documents in a folder of a plurality of folders of a central file system; creating a plurality of indexes for content indexing the plurality of transcribed documents, each of the plurality of indexes being based at least in part on an indexing field; enabling searching of the plurality of transcribed documents based on the plurality of indexes; and automatically recommending to a user a preferred method of distributing a transcribed document of the plurality of transcribed documents to a recipient based at least in part on a preference of the recipient.

Other aspects and features of the invention will become apparent to those ordinarily skilled in the art upon review of the following description of specific embodiments of the invention in conjunction with the accompanying figures.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a top-level diagram of a system for management of transcribed documents of the present invention in communication with a speech recognition system;

FIG. 2 is a block diagram of the preferred embodiment transcription management system for management of transcribed documents;

FIG. 3 is a flow diagram illustrating the flow of transcribed documents in the transcription management system of FIG. 2;

FIG. 4 shows an exemplary screen display of a user interface associated with the transcription management system of FIG. 2;

FIGS. 5A-5B show exemplary screen displays for documents in different folders of the transcription management system of FIG. 2;

FIGS. 6A-6C show exemplary screen displays of a document distribution process of the present invention;

FIG. 7A shows an exemplary screen display of a fax log of the present invention; and

FIG. 7B shows an exemplary screen display of an email log of the present invention.

### DETAILED DESCRIPTION OF THE DRAWINGS

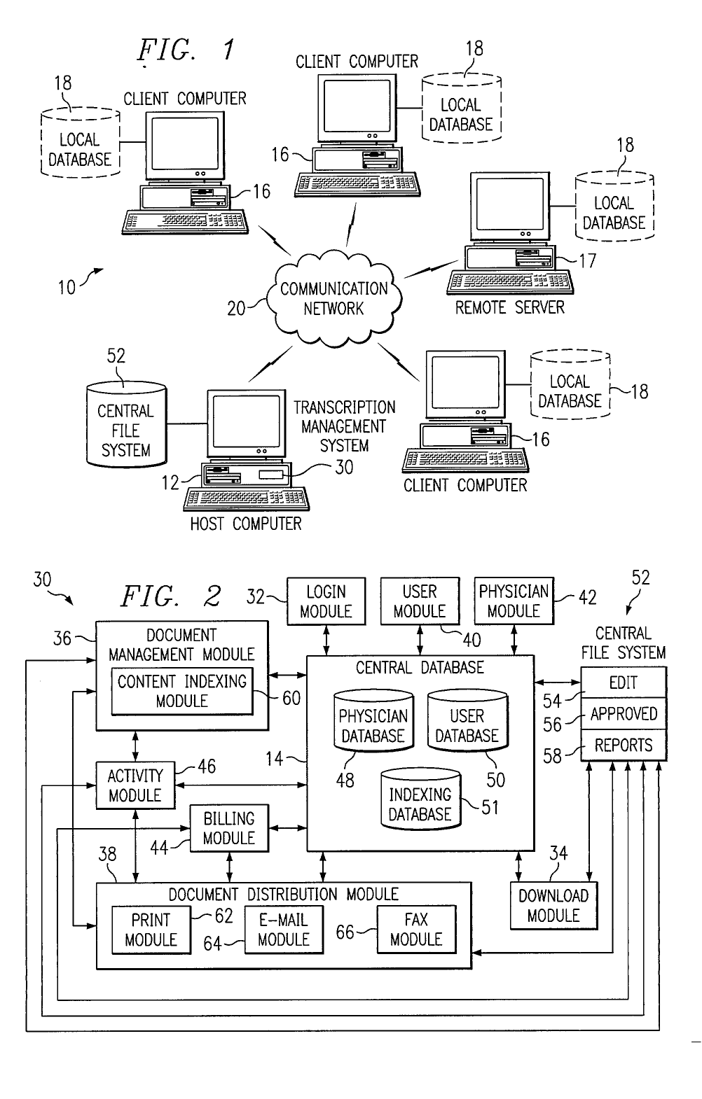

The preferred embodiment of the present invention and its advantages are best understood by referring to FIGS. 1 through 6 of the drawings.

FIG. 1 is a top-level diagram of a system 10 for management of transcribed documents of the present invention in communication with a speech recognition system. System 10 comprises a host computer 12. Host computer 12 preferably acts as a web server and may also serve as a repository for certain data and programs as described in more detail below. Host computer 12 may be any computing device such as a network computer running Windows NT, Novell Netware, Unix, Windows 2000 or any other network operating system. If desired, host computer 12 may be connected to another computing device (not shown) that serves as a firewall to prevent tampering with information stored on or accessible from host computer 12. In an alternative embodiment, the firewall may be part of host computer 12. If desired, other security measures, such as the use of user ID, passwords, retinal scans, fingerprints, facial recognition, voice recognition, and/or the like, may be used to restrict access to information stored on or accessible from host computer 12.

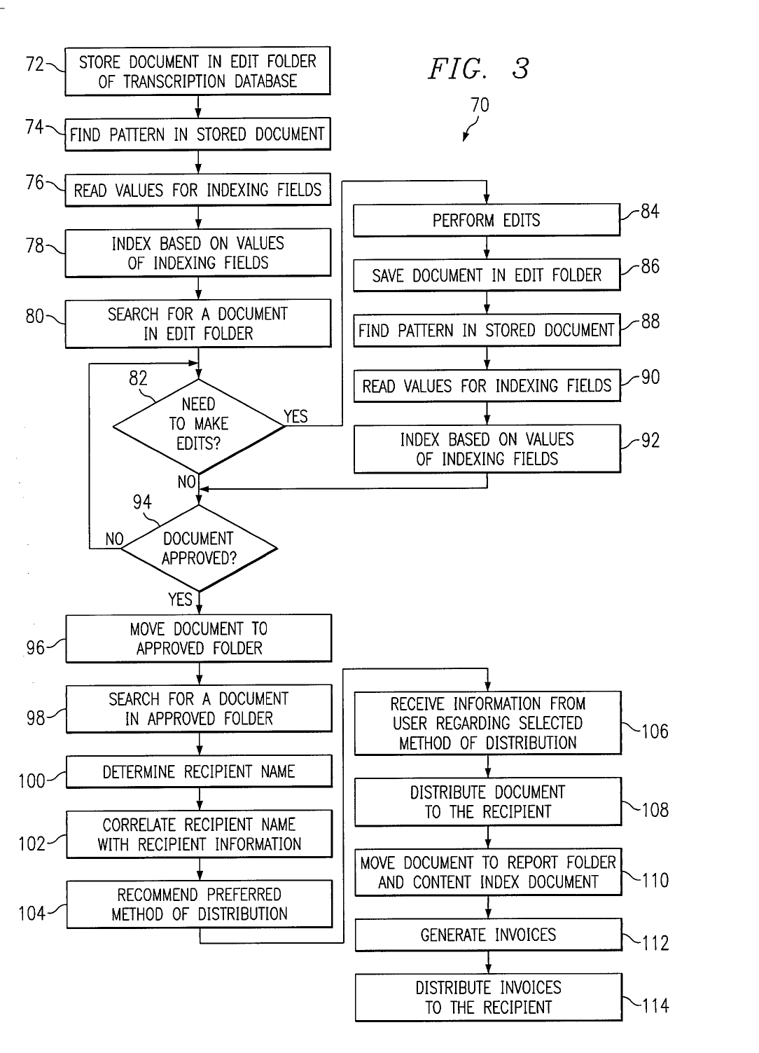

Host computer 12 preferably includes conventional web hosting operating software and includes a device for connecting with the Internet such as a dial-up modem, a cable modem, a wireless modem, a wireless gateway, a xDSL modem, or ISDN converter. Host computer 12 is preferably under the control of a provider of services for management of transcribed documents. In the preferred embodiment, host computer 12 is coupled to or comprises a central file system 52. Central file system 52 preferably serves as a central repository for transcribed documents. The operation and function of central file system 52 is described in more detail herein with reference to FIG. 2. Host computer 12 comprises a transcription management system 30 for management of transcribed documents. System 30 is described in more detail herein below.

One or more client computer(s) 16 may be networked with host computer 12 via communication network 20. One or more remote servers 17 may be networked with host computer 12 via communication network 20. Client computer 16 may be a stand-alone device or multiple computers may be networked together via a communication network (not shown). Each client computer 16 preferably includes a device such as a dial-up modem, a cable modem, a wireless modem, a wireless gateway, a xDSL modem, or ISDN converter and a web browser that permits it to access the Internet via communication network 20. Remote server 17 is preferably a File Transfer Protocol (FTP) server. If desired, remote server 17 may be a web server. Remote server 17 may comprise a local database 18 which serves as a repository for documents transcribed at various locations. In the preferred embodiment, communication network 20 may comprise a public network. In alternative embodiments, communication network 20 may comprise any means of information communication, such as PSTN, wireless communication network, a proprietary network, a general purpose processor-based information network, dedicated communication lines, a computer network, direct PC to PC connection, a local area network, a wide area network, modem to modem connection, an Intranet, an Extranet, a Virtual Private Network (VPN) or any combination thereof suitable for providing information to and from client computer 16.

Preferably, each client computer 16 comprises a speech recognition and transcription system (not shown), such as the speech recognition and transcription system described in the above-referenced patent application, titled “SYSTEM AND METHOD FOR SPEECH RECOGNITION AND TRANSCRIPTION”. However, client computer 16 may comprise other types of speech recognition and transcription systems. In the preferred embodiment, each client computer 16 is coupled to or comprises a local database 18. Local database 18 preferably serves as a repository for documents transcribed at the associated client computer 16. Client computer 16, such as personal computers (PCs), workstations, laptop computers, personal digital assistants (PDAs), wireless phones and/or the like, may be used by users, such as radiologists, physicians, providers of transcription services, providers of services related to management of transcribed documents, and/or the like, to access central file system 52, to generate transcribed documents and/or the like. The group of users may comprise users who utilize the speech recognition and transcription system to generate transcribed documents. Such users are referred to herein as “client users”. However, the term users is used herein to refer to all kinds of users, including but not limited to client users.

FIG. 2 is a block diagram of the preferred embodiment transcription management system 30 residing in host computer 12 for management of transcribed documents. System 30 is preferably a browser-based system. System 30 comprises a login module 32, a download module 34, a document management module 36, a document distribution module 38, a user module 40, a physician module 42, a billing module 44, and an activity module 46, each of these modules being coupled to a central database 14. System 30 also comprises of central file system 52. Preferably, document management module 36 is coupled to document distribution module 38 and activity module 46. Preferably, billing module 44 is also coupled to document distribution module 38. Download module 34, document management module 36, document distribution module 38, billing module 44, and activity module 46 are each preferably coupled to central file system 52.

Central file system 52 serves as a central repository for transcribed documents. In the preferred embodiment, central file system 52 comprises a plurality of folders and each transcribed document is stored in at least one of the folders. Preferably, central file system 52 includes at least three folders—an edit folder 54, an approved folder 56 and a report folder 58. The transcribed documents in edit folder 54 are documents that have been transcribed but not yet approved by a user, such as a client user, for example the radiologist who dictated the report. Transcribed documents in edit folder 54 are to be edited by the radiologist or his/her assistant. The transcribed documents in approved folder 56 are documents that have been approved by the relevant user, for example the radiologist who dictated the report. The documents in approved folder 56 are ready to be distributed to recipients, for example to physicians who need the transcribed documents. The transcribed documents in reports folder 58 are documents that have been distributed. Preferably, documents in edit folder 54 and approved folder 56 are assigned an “active” status and documents in reports folder 58 are assigned an “inactive” status.

Preferably, central database 14 comprises a physician database 48, a user database 50, and an indexing database 51. Each database may comprise one or more tables. Each table preferably comprises a plurality of rows and a plurality of columns. Each row corresponds to a record and each column corresponds to a field of the record. Physician database 48 preferably includes physician information, such as physician code, physician name, address(es), phone number(s), fax number(s), email address(es), physician preferences and/or the like. Physician preferences may include information, such as turnaround time for receiving reports, format/template for the reports, physician's preferred method for receiving transcribed documents, and/or the like. If desired, physician preferences may be stored in a database separate from physician database 48. Physician code may be used as the primary key to relate physician database 48 with the physician preference database.

User database 50 preferably includes user information, such as user ID, name of the user, password information, user status, email address of the user, last login information, user preferences and/or the like. User preferences are preferably stored only for client users and may include information, such as billing preferences of the client user, format/template for the invoices, the client user's preferred method for receiving invoices and/or the like. User ID is preferably a unique identification associated with a user account. User status determines the level of access provided to a particular user and may be one of the following: Administrator, Approver, Power User, Regular User, and/or the like. For example, a user with Administrator status may be able to create new user accounts and control the level of access of other users. The Administrator may allow any user to access system 30. Users in the Approver group may be allowed to make corrections to documents, approve documents, distribute documents, and/or the like. Such users may include, for example, radiologists, their assigned assistants, and/or the like. Users in the Power User group may be allowed to read documents, distribute documents, and/or the like. However, such users are not allowed to approve documents. Users in the Regular User group may be allowed to read documents. However, such users are not allowed to approve documents or distribute documents. If desired, user database 50 may also include information regarding a client user's preferred method for receiving invoices, fee structure for the particular client user, and/or the like.

Indexing database 51 preferably includes indexes to documents in central file system 52. Preferably, indexing database 51 includes the names of the documents in different folders of central file system 52 along with the corresponding indexes which may be used to quickly locate the documents.

Login module 32 is primarily responsible for providing access to central database 14 and central file system 52 to an authorized user. Login module 32 interacts with user database 50 to verify the login and other security information provided by the user and also to determine the level of access to be provided to a particular user.

Download module 34 is primarily responsible for enabling the downloading of documents and/or data, such as transcribed documents, digital sound recordings from which the documents were transcribed and/or the like, from databases stored at remote locations, such as for example databases 18. Thus, for example, transcribed documents created using a speech recognition and transcription system and stored in a remote database may be downloaded to central file system 52 and stored in edit folder 54. A download log may be maintained, for example in central database 14, to keep track of documents that have been downloaded and other download data, such as the date and time of the download. Thus, duplicate document downloads may be avoided.

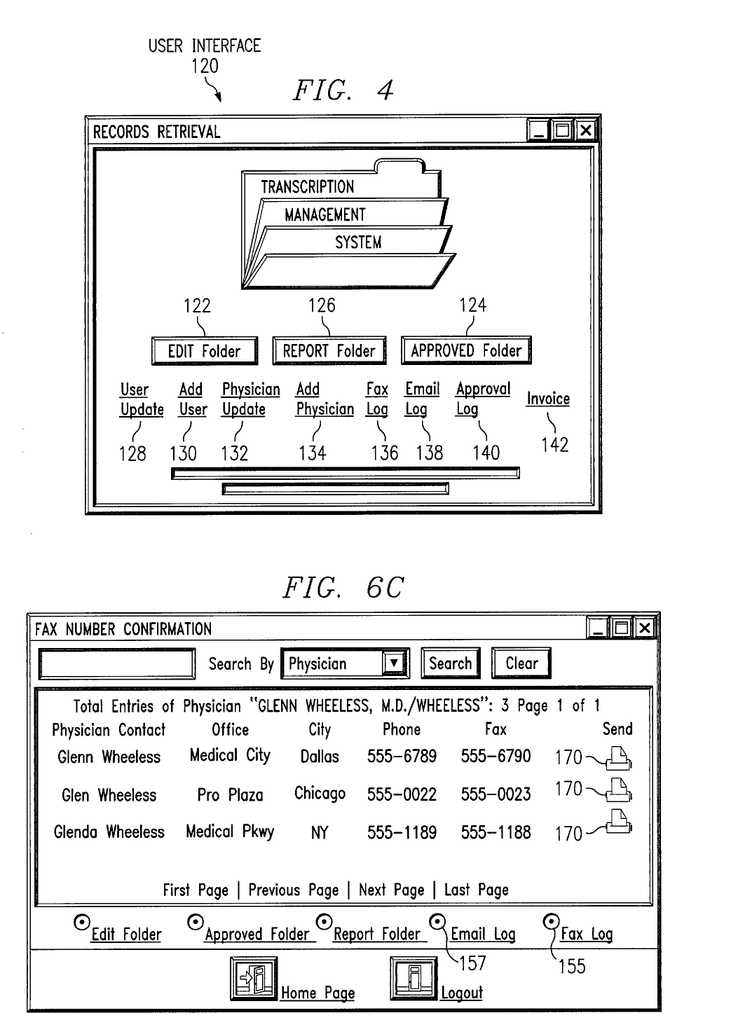

Document management module 36 is primarily responsible for managing the transcribed documents in the different folders—edit folder 54, approved folder 56 and reports folder 58. Document management module 36 may also present data to the user on a monitor associated with client computer 16 or host computer 12. If desired, document management module 36 may also allow a user to search for and retrieve documents based on search criteria provided by the user. Document management module 36 preferably includes a content indexing module 60. Content indexing module 60 is primarily responsible for indexing the transcribed documents based at least in part on their content, such as patient name, physician name, chart number, type of study, date of study and/or the like. The process of content indexing is described in more detail herein with reference to FIG. 3.

Document distribution module 38 is primarily responsible for the distribution of documents, such as transcribed documents, invoices and/or the like. Preferably document distribution module 38 makes recommendations to the user regarding the preferred method of distributing transcribed documents to recipients, such as physicians, based at least in part on preferences and/or contact information stored in physician database 48 of central database 14. If desired, document distribution module 38 may make recommendations to the user regarding the preferred method of distributing documents to client users, such as radiologists, based at least in part on preferences and/or contact information stored in user database 50 of central database 14.

Document distribution module 38 preferably comprises a print module 62, an email module 64, and a fax module 66. Print module 62 formats the document to be distributed preferably based on the preferences of the recipient as may be specified for example in physician database 48. Alternatively or additionally, print module 62 may format the pages of the document based on user specified criteria. If desired, print module 62 may also format invoices to be distributed to a recipient, such as for example a client user, based on the preferences of the recipient as may be specified for example in user database 50.

Email module 64 interacts with physician database 48 in central database 14 to retrieve the email address of the recipient and provide it to the user. If desired, email module 64 may also interact with user database 50 in central database 34 to retrieve the email address of client users. If the recipient/client user has multiple email addresses, email module 64 may present the information and make a recommendation about the email address to which the document/invoice should be sent. Email module 64 preferably allows the user to click on an on-screen icon and email the document/invoice to the recipient. Preferably email module 64 is coupled to an email exchange server (not shown) to send and receive email. If desired, other types of email servers may be used.

Fax module 66 interacts with physician database in central database 14 to retrieve the fax number of the recipient and provide it to the user. If desired, fax module 66 may also interact with user database 50 in central database 34 to retrieve the fax numbers of client users. If the recipient/client user has multiple fax numbers, fax module 66 may present the information and make a recommendation about the fax number to which the document/invoice should be sent. Fax module 66 preferably allows the user to click on an on-screen icon and fax the document/invoice to the recipient. Preferably fax module 66 is coupled to a fax server (not shown) using an Application Programming Interface (API). Fax module 66 uses the web server resources to prepare documents/invoices to be faxed out thereby speeding up the faxing process.

User module 40 is primarily responsible for enabling the system Administrator to manage user information. User module 40 allows the system Administrator to add a user, delete a user, update user information, and/or the like. User module 40 interacts with user database 50 and updates the information stored in user database 50.

Physician module 42 is primarily responsible for enabling the system Administrator or other authorized user to manage physician information. Physician module 42 allows the system Administrator or other authorized user to add, delete, update physician information, and/or the like. Physician module 42 interacts with physician database 48 to complete these tasks.

Billing module 44 is primarily responsible for generating invoices. In the preferred embodiment, the amount due is based on the number of words in the transcribed document or the number of lines or number of pages in the transcribed document. Preferably the method of calculation of the amount due is based on the fee arrangement with the particular client user stored in user database 50. If desired, billing module 44 may also format the invoice based on the preference of the recipient of the invoices stored in user database 50. For example, some recipients may prefer to have the details of the number of lines, words and/or pages processed for each document in the invoices. In such cases, the number of words, lines and/or pages processed for each document for which an invoice is being sent is included in the invoice by billing module 44.

Activity module 46 is primarily responsible for keeping track of activity associated with system 30. Thus, for example, with regard to transcribed documents in approved folder 54, activity module 46 may store the following information: the approve ID, the name of the person who approved the transcribed document, the physician name, the patient name, the chart number, the date the transcribed document was approved, the title of the transcribed document, and/or the like. Approve ID is a unique ID that serves as the primary key with regard to transcribed documents in approved folder 54. With regard to transcribed documents that have been transmitted to the recipient by email, activity module 46 may store the following information: the log ID, the recipient name, the sender ID, the sender name, the email address of the recipient, the fax number of the recipient, the name of patient, the title of the transcribed document, the MRI type of the transcribed document, the status of the email, the reason for failure, if any, and/or the like. Log ID is a unique ID that serves as the primary key with regard to transcribed documents that have been transmitted to the recipient by email. With regard to transcribed documents that have been transmitted to the recipient by fax, activity module 46 may store the following information: the fax ID, the date the fax was transmitted, the time the fax was transmitted, the recipient name, the fax number of the recipient, the number of pages transmitted, the result of the fax operation, information regarding reason for failure, if any, the title of the transcribed document, the patient name, the MRI type of the transcribed document and/or the like. Fax ID is a unique ID that serves as the primary key with regard to transcribed documents that have been transmitted to the recipient by fax.

FIG. 3 is a flow diagram 70 illustrating the flow of transcribed documents in transcription management system 30 of FIG. 2. In step 72, one or more transcribed documents are stored preferably in edit folder 54 of central file system 52. The stored document may be any transcribed document, such as a radiology report, a patient history, a lab report, a physician referral form, a surgery note, and/or the like.

In the preferred embodiment, the transcribed documents are downloaded from a remote location, such as database 18 (FIG. 1) associated with client computer 16 or remote server 17 via communication network 20, which may comprise the Internet, for storage in edit folder 54. The transcribed documents to be download may have been previously stored in a public folder in database 18. Preferably the download operation is performed by download module 34.

In an alternative embodiment, the transcribed documents are retrieved from a local database or storage, such as database 18 (FIG. 1) associated with client computer 16 via communication network 20, which may comprise a local area network. In such an embodiment, the transcribed documents may be moved into edit folder 54 from one or more shared network drives.

Once a transcribed document is stored in central file system 52, content indexing of the stored document is performed preferably by content indexing module 60. In step 74, the stored document is read preferably by content indexing module 60 to find a predefined pattern in the stored document. A pattern preferably comprises a plurality of indexing fields, each indexing field followed by the value for the corresponding indexing field. The indexing fields may be separated from each other by a separator, for example a comma. The particular pattern to be used, including the indexing fields and separators, may be based on physician preferences and may be stored in physician database 48. An exemplary pattern for a radiology report may be: “PATIENT NAME: Patient name”, “PHYSICIAN NAME: Physician name”, “CHART NUMBER: Chart number”, “MRI DATE: MRI date”, “MRI STUDY: MRI study.”

The present invention will be described herein with reference to the above exemplary pattern. However, the invention is not so limited and other patterns may be used without departing from the scope of the present invention.

In step 76, values for the indexing fields in the pattern are read from the stored document. In step 78, the stored document is indexed based at least in part on the values for the indexing field. Thus, for example, if the physician name is John Doe, then the stored document is indexed, in the index based on the physician name field, with John Doe as the index. The indexes along with the corresponding document names are preferably stored in indexing database 51. The above process is repeated for all indexes based on the different indexing fields.

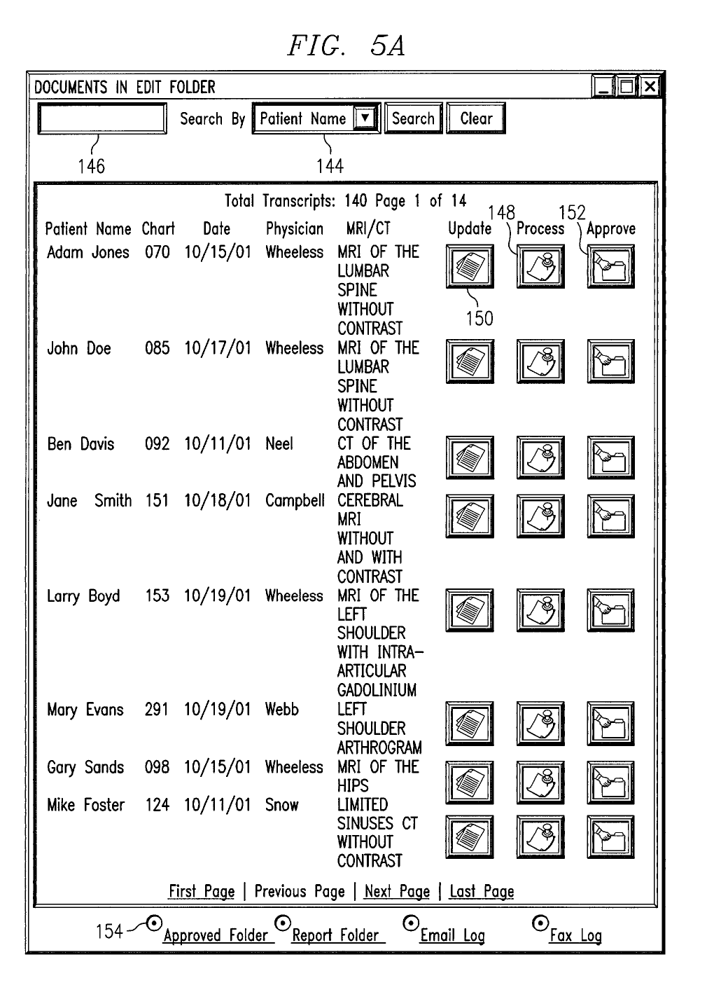

FIG. 4 shows an exemplary screen display of a user interface 120, for example an Internet browser, associated with system 30. Once a user has successfully logged onto system 30, the user is presented with a plurality of options: Records Retrieval From Edit Folder 122; Records Retrieval From Approved Folder 124; Records Retrieval From Report Folder 126; User Update 128; Add User 130; Physician Update 132; Add Physician 134; Fax Log 136; Email Log 138; Approval Log 140; Invoice 142 and/or the like. The user may select one or more of the above options depending on the level of access permission assigned to the user. For example, only a user with Administrator status is allowed to select Add User option 130. If desired, the users may be provided only with the options for operations that they are allowed to perform.

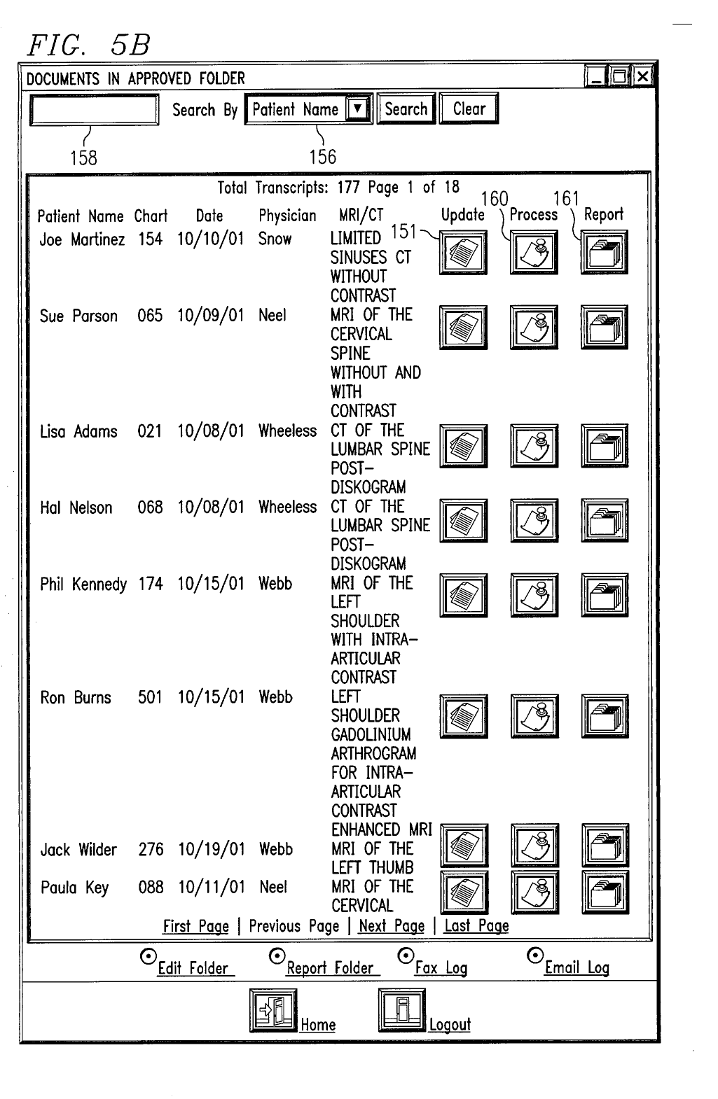

Referring back to FIG. 3, once a stored document has been content indexed, edit folder 54 may be searched based on different criteria (step 80). The user may search edit folder 54 by selecting Records Retrieval From Edit Folder 122 option. FIG. 5A shows an exemplary screen display for documents in edit folder 54. In the preferred embodiment, documents may be searched based on any of the indexing fields. An indexing field may be selected by clicking on a drop down menu button 144 (shown in FIG. 5A). A search box 146 may be provided in which the user may enter the search term. The search is preferably performed by document management module 36. Thus, in the preferred embodiment, instead of searching all documents in central file system 52, only the documents in, edit folder 54 of the particular physician may be searched, thereby reducing the search time. Once the search has been performed the results may be displayed to the user as shown, for example, in FIG. 5A.

In step 82 a determination is made as to whether the user needs to make edits. If the user needs to make edits, then the user may select the document, for example by selecting the Patient Name or any other field corresponding to the transcribed document that the user desires to edit. In step 84, the desired edits are performed by the user. Once the desired edits have been performed the document may be saved back in edit folder 54 (step 86). Once the document is saved back in edit folder 54, the user may select an update option, for example by selecting an Update icon 150 corresponding to the transcribed document that the user desires to update. In step 88, the document to be updated is read preferably by content indexing module 60 to find a pattern in the stored document. In step 90, values for the indexing fields in the pattern are read from the stored document. In step 92, the stored document is indexed based at least in part on the values for the indexing field. The information displayed on the screen display of FIG. 5A may also be updated.

In step 94, a determination is made as to whether a particular transcribed document has been approved. The user may approve a document by selecting an Approve option, for example by selecting an Approve icon 152 corresponding to the transcribed document that the user desires to approve. If desired, the user may also make a note in the document itself, for example by selecting an Approve macro from a word processing software, indicating that the document has been approved. If the transcribed document has not been approved then the process starting at step 82 may be repeated. In step 96, the approved document is moved to approved folder 56 preferably by document management module 36.

Once a stored document has been moved to approved folder 56, approved folder 56 may be searched based on different criteria (step 98). The user may search approved folder 56 by selecting Records Retrieval From Approved Folder 124 option (FIG. 5A) or by selecting approved folder option 154 (FIG. 5A). FIG. 5B shows an exemplary screen display for documents in approved folder 56. In the preferred embodiment, documents may be searched based on any of the indexing fields. An indexing field may be selected by clicking on a drop down menu button 156 (shown in FIG. 5B). A search box 158 may be provided in which the user may enter the search term. The search is preferably performed by document management module 36. Thus, in the preferred embodiment, instead of searching all documents in central file system 52, only the documents in approved folder 56 may be searched thereby reducing the time to perform the search. Once the search has been performed the results may be displayed to the user as shown, for example, in FIG. 5B.

If desired, the user may select an update option, for example by selecting an Update icon 151 (FIG. 5B) corresponding to the transcribed document that the user desires to update. The document to be updated may be read preferably by content indexing module 60 to find a pattern in the stored document. The stored document may be indexed based at least in part on the values for the indexing fields. The information displayed on the screen display of FIG. 5B may also be updated.

Documents in approved folder 56 of central file system 52 are intended to be distributed to recipients, for example physicians, hospitals and/or the like. The user may distribute an approved document by selecting a process option, for example by selecting a Process icon 160 (FIG. 5B) corresponding to the transcribed document that the user desires to distribute. The process option may also be selected by selecting a Process icon 148 as shown in FIG. 5A corresponding to the transcribed document that the user desires to distribute.

In step 100, the name of the recipient, for example a physician, is determined. Preferably, the name of the recipient is determined by looking-up the physician name index associated with the document to be distributed.

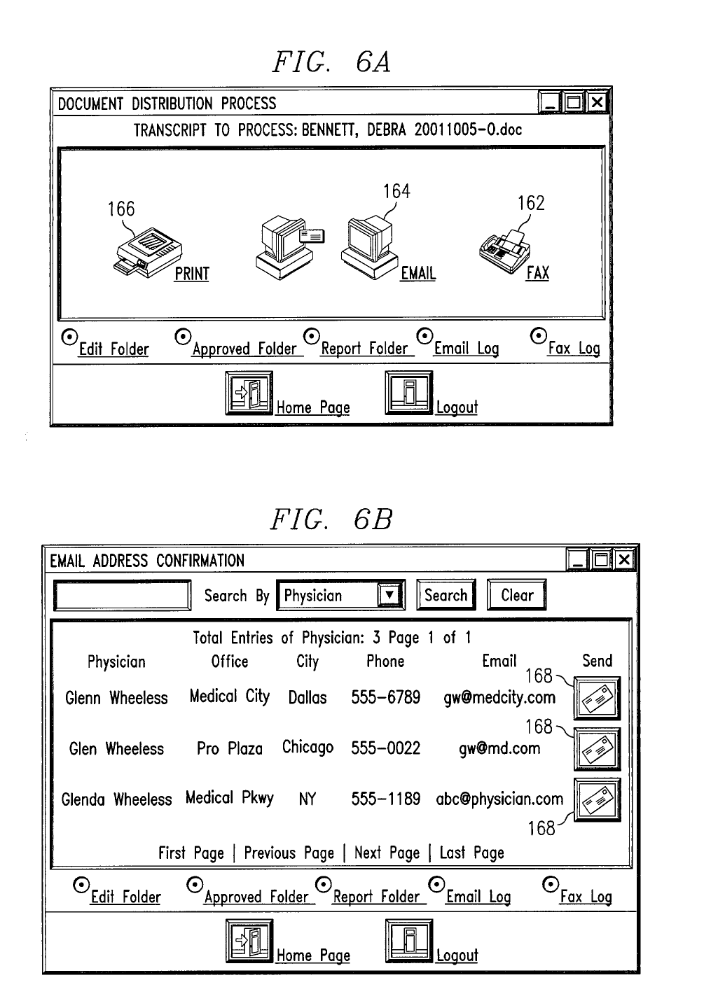

In step 102, the determined recipient name is correlated with recipient information. Preferably, the correlation is performed with information stored in physician database 48 by document distribution module 38. In step 104, document distribution module 38 provides a recommendation to the user regarding the preferred method of distribution for the particular recipient based on recipient preferences as stored in physician database 48. If desired, other options for distributing the approved document to the particular recipient may also be provided with the preferred method of distribution highlighted. Thus, for example as shown in FIG. 6A, the user may be presented with a fax option 162, an email option 164, a print option 166, and/or the like.

If desired, information about the recipient's preferred format for transcribed documents may be retrieved from physician database 48. The retrieved preferred format for the transcribed document may be communicated to print module 62 (FIG. 2). Print module 62 may format the transcribed document based at least in part on the preference of the recipient. If desired, the user may select print option 166 to format and print the document based on user specified criteria. For example, a user may require printing of the document on specifically designed paper with different types of information, such as the user's logo, user's contact information, participating radiologist name list, and/or the like. Additionally or alternatively, a user may specify types of fonts to be used, font size, page margins and/or the like.

The user may select any of the methods of distribution by selecting a desired option. In step 106, information regarding the method of distribution selected by the user is received preferably by document distribution module 38. Upon receiving information from the user regarding the selected method of distribution, information related to the selected method of distribution is presented to the user preferably by the module associated with the selected method of distribution. Thus, for example, if the user selects email option 164, an email address confirmation page as shown, for example, in FIG. 6B may be presented to the user, preferably by email module 64. In the example illustrated in FIG. 6B, more than one entry corresponding to the physician and including the physician's email address is presented. In the case of multiple entries for the same physician, the listing may be arranged such that the most preferred email address is at the top and the least preferred email address is at the bottom of the list. If desired, the preferred email address of the physician is highlighted. Multiple email addresses may be highlighted, if desired. Thus, for example, if the physician has indicated that a particular transcribed document is of very high importance, then the physician's office email address and also the physician's personal email address may be highlighted. Also, if desired, the physician's assistant's email address may also be presented for consideration. The user may distribute the document to the desired email address by selecting a send option, for example by selecting a Send icon 168 (FIG. 6B) corresponding to the listing of the email address to which the document is to be distributed.

FIG. 6C shows an exemplary fax number confirmation page which may be presented to the user in response to receiving information indicating that the method of distribution selected by the user is fax transmission, for example when the user selects fax option 162 (FIG. 6A). In the example illustrated in FIG. 6C, more than one entry corresponding to the physician and including the physician's fax number is presented, preferably by fax module 66. In the case of multiple entries for the same physician, the listing may be arranged such that the most preferred fax number is at the top and the least preferred fax number is at the bottom of the list. If desired, the preferred fax number of the physician is highlighted. Multiple fax numbers may be highlighted, if desired. Thus, for example, if the physician has indicated that a particular transcribed document is of very high importance, then the physician's office fax number and also the physician's personal fax number may be highlighted. Also, if desired, the physician's assistant's fax number may also be presented for consideration. The user may distribute the document to the desired fax umber by selecting a send option, for example by selecting a Send icon 170 (FIG. 6C) corresponding to the listing of the fax number to which the document is to be distributed.

In step 108, the transcribed document is distributed to the recipient by the user selected method. If the user desires to move a document from Approved folder 56 to Reports folder 58, then the user may select a Report option, for example by selecting a Report icon 161 (FIG. 5B) corresponding to the transcribed document that the user desires to move to Reports folder 58. In step 110, if desired, the distributed document may be moved to Reports folder 58. The distributed document may also be content indexed, for example by following the procedure as described herein with reference to steps 88, 90 and 92. Also, if desired, in this step the document is changed to an inactive status as the document has already been distributed to the recipient. A document may be moved to Reports folder 58 if it is not going to be used frequently.

In step 112, invoice(s) are generated based at least in part on the preference of the client user receiving the invoice. In the preferred embodiment, billing module 44 interacts with user database 50 to determine the fee structure for a particular client user. Once the fee structure is determined, invoices are generated based on the determined fee structure. Thus, for example, if the agreed upon fee structure is based on the number of words in the transcribed document, then the number of words in the transcribed document is determined and the amount owed is calculated based on the determined number of words in the transcribed document. On the other hand, if the agreed upon fee structure is based on the number of lines in the transcribed document, then the number of lines in the transcribed document is determined and the amount owed is calculated based on the determined number of lines in the transcribed document.

If desired, information about the client user's preferred format for invoices may be retrieved from user database 50, preferably by billing module 44. The retrieved preferred format for the invoice may be communicated to print module 62 (FIG. 2). Print module 62 may format the invoice based at least in part on the preference of the client user.

In step 114, the invoice is distributed to the client user preferably by document distribution module 38. If desired, the process described above with reference to distribution of a transcribed document to a recipient (steps 102, 104, 106 and 108) may be used to distribute the invoice to the client user. Information regarding the client user's preferred method for receiving invoices may be retrieved from user database 50.

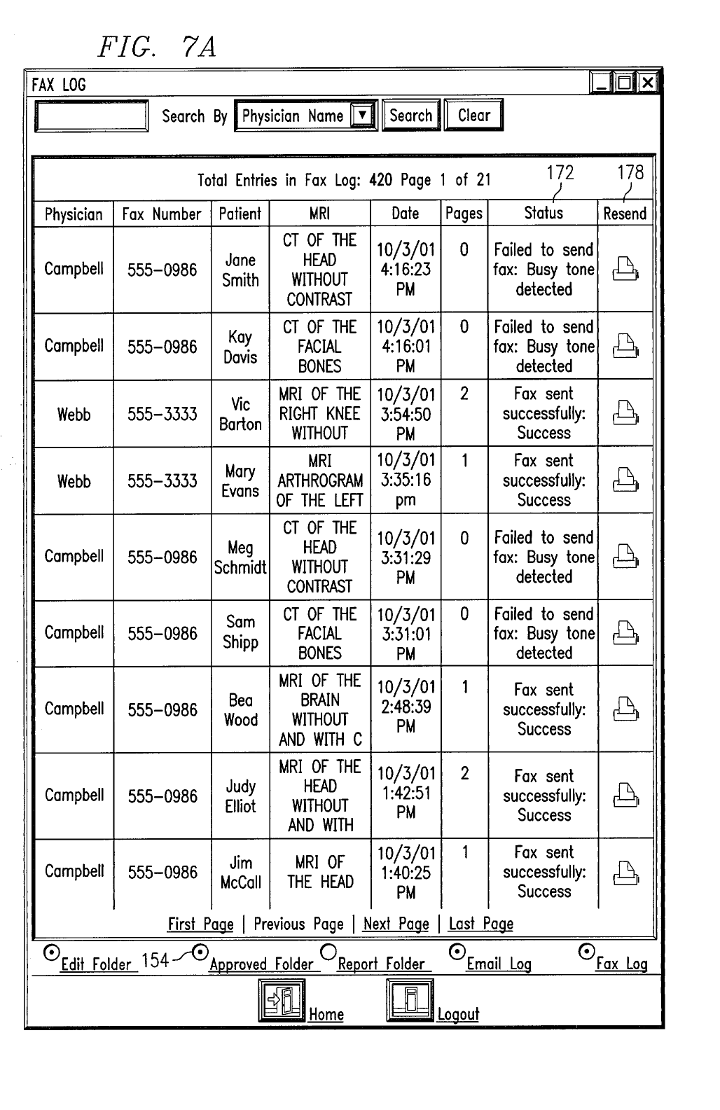

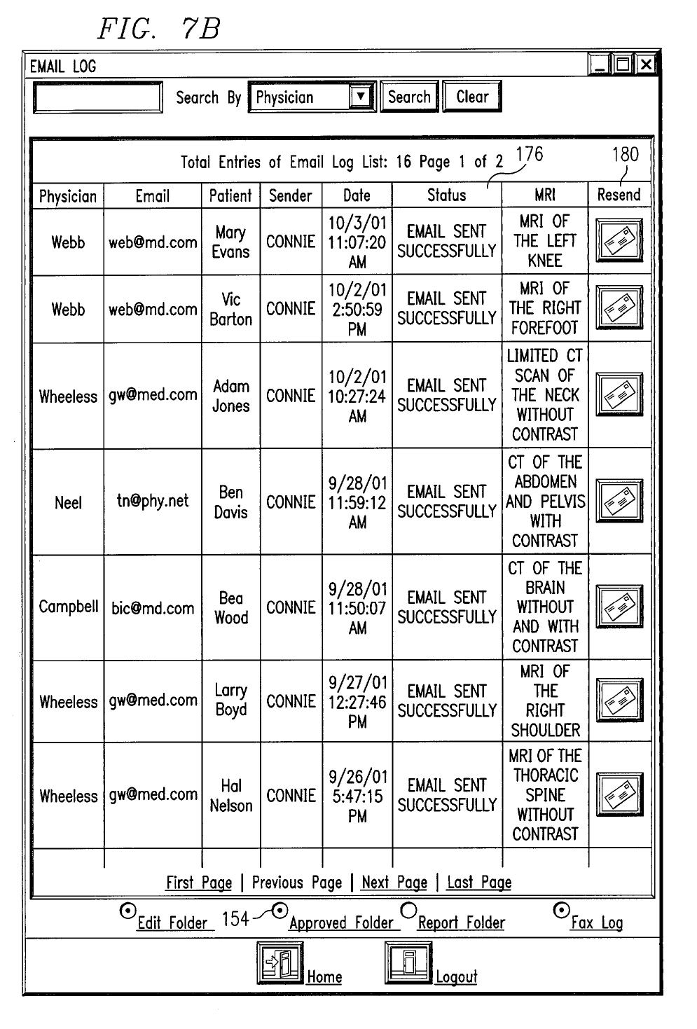

The user may select a fax log option 155 (FIG. 6C) to view a log of all faxes. FIG. 7A shows an exemplary screen display of a fax log of the present invention. As can be seen from FIG. 7A, the fax log provides information about faxes, such as physician name, fax number, patient name, MRI, date the fax was transmitted, number of pages transmitted, status of the fax, and/or the like. Status column 172 provides status information about the fax. Status information may include information such as whether the fax was sent successfully or not, reason for failure if a fax transmission failed, and/or the like. A Resend icon 178 may be provided after each entry. A user may select a Resend option, for example by clicking Resend icon 178 corresponding to a particular entry to resend the corresponding fax.

The user may select an email log option 157 (FIG. 6C) to view a log of all emails. FIG. 7B shows an exemplary screen display of an email log of the present invention. As can be seen from FIG. 7B, the email log provides information about emails, such as physician name, email address, patient name, sender name, date the email was transmitted, status of the email, MRI, and/or the like. Status column 174 provides status information about the email. Status information may include information such as whether the email was sent successfully or not, reason for failure if an email transmission failed, and/or the like. A Resend icon 180 may be provided after each entry. A user may select a Resend option, for example by clicking Resend icon 180 corresponding to a particular entry to resend the corresponding email.

Although the preferred embodiment of the present invention has been described above with different modules performing different operations, the invention is not so limited. One or more of the above described modules may be combined without departing from the scope of the present invention. Furthermore, although the preferred embodiment of the present invention has been described above with different databases storing different types of information, the invention is not so limited. One or more of the above described databases may be combined without departing from the scope of the present invention.

Although, the preferred embodiment of the present invention has been described above with reference to transcribed documents, the invention is not so limited. If desired, the teachings of the present invention may be used to manage and distribute other types of documents without departing from the scope of the present invention.

While the invention has been particularly shown and described by the foregoing detailed description, it will be understood by those skilled in the art that various other changes in form and detail may be made without departing from the spirit and scope of the invention.

What is claimed is:

1. A transcription management system, comprising:
a central file system for storing a plurality of documents, each of said plurality of documents being stored in only one of at least two folders in said central file system based at least in part on a respective status of said plurality of documents;
a content indexing module operable to index each of said plurality of documents stored in said central file system based at least in part on the respective content of said plurality of documents stored in said central file system; and
a document management module operable to manage the processing and distribution of said plurality of documents stored in said central file system in response to, at least in part, the respective status of said plurality of documents.

2. The transcription management system of claim 1, wherein each of a selected plurality of said plurality of documents comprises a transcribed document.

3. The transcription management system of claim 1, further comprising a database for storing information regarding a plurality of recipients.

4. The transcription management system of claim 3, wherein at least one of said plurality of recipients is a physician.

5. The transcription management system of claim 3, further comprising a document distribution module operable to distribute at least one of said plurality of documents to at least one of said plurality of recipients based at least in part on a preference of said at least one recipient stored in said database.

6. The transcription management system of claim 5, wherein said document distribution module is further operable to recommend to a user a preferred method of distributing said at least one of said plurality of documents to said at least one of said plurality of recipients.

7. The transcription management system of claim 6, wherein said recommendation is based at least in part on information about said at least one of said plurality of recipients stored in said database.

8. The transcription management system of claim 1, further comprising a billing module operable to generate an invoice for at least one of said plurality of documents.

9. The transcription management system of claim 8, wherein said invoice is generated based at least in part on the number of words in said at least one of said plurality of documents.

10. The transcription management system of claim 8, wherein said invoice is generated based at least in part on the number of lines in said at least one of said plurality of documents.

11. The transcription management system of claim 1, wherein said content of each of said plurality of documents comprises a predefined pattern.

12. The transcription management system of claim 11, wherein said predefined pattern comprises a plurality of indexing fields, at least one of said plurality of indexing fields having a value associated with it.

13. The transcription management system of claim 12, wherein at least one of said plurality of indexing fields is selected from the group consisting of a patient name, a physician name, a chart number, an MRI date, and an MRI study.

14. The transcription management system of claim 1, wherein said document management module is further operable to search a folder of said at least two folders for documents matching a user specified criteria.

15. The transcription management system of claim 1, wherein at least one of said plurality of documents comprises a transcribed radiology report.

16. A method for management of transcribed documents, comprising:
storing a plurality of transcribed documents in a folder of a plurality of folders of a central file system;
creating a plurality of indexes for content indexing said plurality of transcribed documents, each of said plurality of indexes being based at least in part on an indexing field;
enabling searching of said plurality of transcribed documents based on said plurality of indexes; and
automatically recommending to a user a preferred method of distributing a transcribed document of said plurality of transcribed documents to a recipient based at least in part on a preference of said recipient.

17. The method of claim 16, further comprising determining the name of said recipient.

18. The method of claim 17, wherein said recipient is a physician.

19. The method of claim 17, further comprising correlating said name of said recipient with information about said recipient stored in a physician database.

20. The method of claim 16, further comprising:
reading the contents of said transcribed document to find a pattern in said transcribed document, wherein said pattern comprises a plurality of indexing fields, at least one of said plurality of indexing fields having a value associated with it; and
indexing said transcribed document based on said value of said at least one of said plurality of indexing fields.

21. The method of claim 16, further comprising distributing said transcribed document to said recipient in response to receiving information from said user regarding a selected method of distribution.

22. A method for management of transcribed documents, comprising:
storing a plurality of transcribed documents in a first folder of a plurality of folders of a central file system;
moving at least one of said plurality of transcribed documents to a second folder in said central file system upon receiving approval for said at least one transcribed document;
automatically recommending to a user a preferred method of distributing said at least one transcribed document to a recipient based at least in part on a preference of said recipient; and
transmitting said at least one transcribed document to said recipient in response to receiving information from said user regarding a selected method of distribution.

23. The method of claim 22, further comprising generating an invoice for said at least one transcribed document.

24. The method of claim 22, further comprising generating an invoice for said transmitted document based at least in part on the number of words in said at least one transcribed document.

25. The method of claim 22, further comprising generating an invoice for said transmitted document based at least in part on the number of lines in said at least one transcribed document.

26. The method of claim 22, further comprising moving said at least one transcribed document to a third folder in said central file system after transmission of said at least one transcribed document to said recipient.

27. The method of claim 22, wherein said recipient is a physician.
